(19) United States
(12) Patent Application Publication
(10) Pub. No.: US 2020/0378441 A1
(43) Pub. Date: Dec. 3, 2020

(54) ALL-CERAMIC JOINT BEARING USED IN HIGH-TEMPERATURE, CORROSION AND OXIDATION-PRONE WORKING ENVIRONMENT

(71) Applicant: Shenyang Jianzhu University, Shenyang (CN)

(72) Inventors: Yuhou WU, Shenyang (CN); Jian SUN, Shenyang (CN); Junxing TIAN, Shenyang (CN); He WANG, Shenyang (CN); Wenzheng CHEN, Shenyang (CN); Zhongxian XIA, Shenyang (CN); Longfei GAO, Shenyang (CN); Ke ZHANG, Shenyang (CN)

(21) Appl. No.: 16/838,217

(22) Filed: Apr. 2, 2020

(30) Foreign Application Priority Data
May 30, 2019 (CN) 201910462704.3

(51) Int. Cl. F16C 33/62; F16C 33/56; F16C 33/46

(52) U.S. Cl. CPC F16C 33/62; F16C 33/4688; F16C 33/56

(57) ABSTRACT

The present invention provides an all-ceramic joint bearing used in a high-temperature, corrosion and oxidation-prone environment, which mainly includes an inner ring and an outer ring which are made of zirconia, alumina or silicon carbide ceramic materials. The all-ceramic joint bearing is assembled into a whole through corresponding assembly technologies. An inner side of the outer ring is an inner arc surface, and the inner ring is an outer arc surface. A width of the inner ring is 3-5 mm greater than that of the outer ring, and a movable swing angle of the inner ring is 0-21°. The joint bearing made of the ceramic materials has an optimized structure by utilizing the ceramic material characteristics of high temperature resistance, corrosion resistance, high hardness, non-magnetic permeability, wear resistance and self-lubrication.

### RELATED APPLICATIONS

This application claims the benefit of priority from Chinese Application No. 201910462704.3 filed May 30, 2019, the disclosures of which are incorporated herein by reference in their entirety.

### TECHNICAL FIELD

The present invention relates to the field of bearings, and in particular, to an all-ceramic joint bearing used in a high-temperature, corrosion and oxidation-prone environment.

### BACKGROUND

A joint bearing is a special bearing with a simple structure and strong anti-impact capability and can perform swing motion to achieve a self-aligning effect. The joint bearing has been widely used in the fields of automobiles, ships, aerospace, etc. In recent years, with the rapid development of China's shipping industry and aerospace industry, joint bearings have been commonly used in aircrafts and ships. However, common metal joint bearings have many defects , for example, poor corrosion resistance and oxidation resistance and difficulty in ensuring an effective service life in a high-temperature working environment. All these restrict wider use of metal joint bearings. However, ceramic materials have excellent wear resistance, corrosion resistance, high temperature resistance, low temperature resistance, high hardness, low coefficient of thermal expansion, electrical insulation, non-magnetic permeability and other excellent properties, as well as self-lubricating properties. Using ceramic materials to manufacture joint bearings can effectively improve the application field of joint bearings, solve the defects of metal materials, and promote the development of the shipping industry and aviation industry.

### SUMMARY

In view of applications in a high-temperature, corrosion and oxidation-prone environment, the present invention provides an all-ceramic joint bearing with high temperature resistance, corrosion resistance, oxidation resistance and self-lubricating properties. The bearing can be used in the fields of aviation, ship manufacturing, etc., and features high technical content, good performance and wide adaptability.

The technical solution of the present invention is as follows:

an all-ceramic joint bearing used in a high-temperature, corrosion and oxidation-prone environment, including an inner ring and an outer ring, where an inner side of the outer ring is an inner arc surface, and an outer side of the outer ring is a cylindrical outer surface; an outer side of the inner ring is an outer arc surface, and an inner side thereof is a hollow cylinder; a bearing width of the inner ring is 3-5 mm greater than that of the outer ring, and a swing angle of the inner ring is 0-21°; an inner wall of the outer ring is closely attached to an outer wall of the inner ring; and the inner ring and the outer ring are made of zirconia, alumina or silicon carbide ceramic materials.

Further, a diameter of the hollow cylinder is 37.5% that of the outer side of the outer ring, and a wall thickness of the outer ring is 1-4 mm.

Further, upper and lower ends of the inner side of the outer ring are provided with inclination angles.

Further, a surface of the inner ring is plated with a layer of diamond powder and the inner arc surface of the outer ring is plated with a layer of graphene.

Beneficial effects of the present invention:

In the present invention, the inner ring and the outer ring of the joint bearing are both made of ceramic materials. With the self-lubricating effect of the ceramic materials, the joint bearing does not require a grooving lubricating structure. Accordingly, the present invention improves strength of the joint bearing, optimizes its structure, simplifies the manufacturing process with reduced production cost, and enhances the production efficiency. A friction coefficient of the ceramic materials is much lower than that of metal materials, which reduces a friction pair between joint bearings and improves the service life of the joint bearing. The ceramic materials are resistant to high temperature, have good thermal stability, and can be used in a high-temperature environment. Moreover, the ceramic materials are resistant to oxidation and corrosion, and are suitable for working conditions such as acid and alkali. Furthermore, the ceramic materials are used in the manufacture of joint bearing materials, and improve properties and application range of the joint bearings.

### BRIEF DESCRIPTION OF THE DRAWINGS

FIG. 1 is a schematic assembly diagram of an all-ceramic joint bearing used in a high-temperature, corrosion and oxidation-prone environment in an implementation of the present invention;

FIG. 2 is a structural sectional view of an all-ceramic joint bearing used in a high-temperature, corrosion and oxidation-prone environment in an implementation of the present invention;

FIG. 3 is a front view of an all-ceramic joint bearing used in a high-temperature, corrosion and oxidation-prone environment in an implementation of the present invention;

FIG. 4 is a left view of an all-ceramic joint bearing used in a high-temperature, corrosion and oxidation-prone environment in an implementation of the present invention;

FIG. 5 is an outer ring of an all-ceramic joint bearing used in a high-temperature, corrosion and oxidation-prone environment in an implementation of the present invention; and

FIG. 6 is an inner ring of an all-ceramic joint bearing used in a high-temperature, corrosion and oxidation-prone environment in an implementation of the present invention.

In the figure, 1. inner ring, 1-1. hollow cylinder, 2. outer ring, 2-1. inclination angle.

### DETAILED DESCRIPTION

In order to further describe the present invention, the present invention is described in detail below with reference to the accompanying drawings and embodiments, but the accompanying drawings and embodiments should not be understood as limiting the protection scope of the present invention.

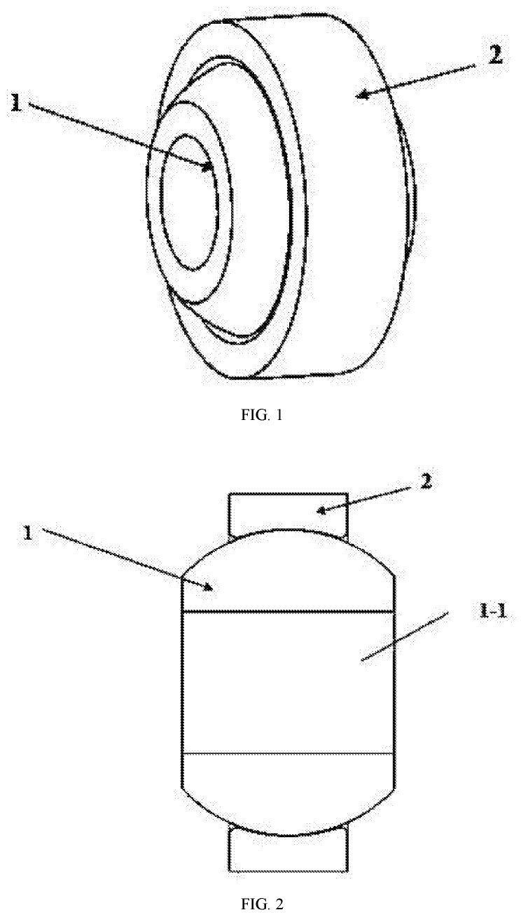

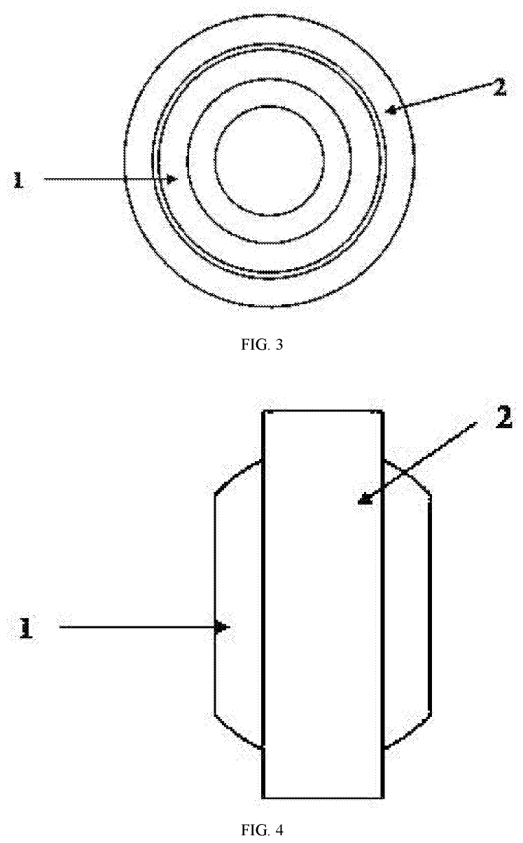

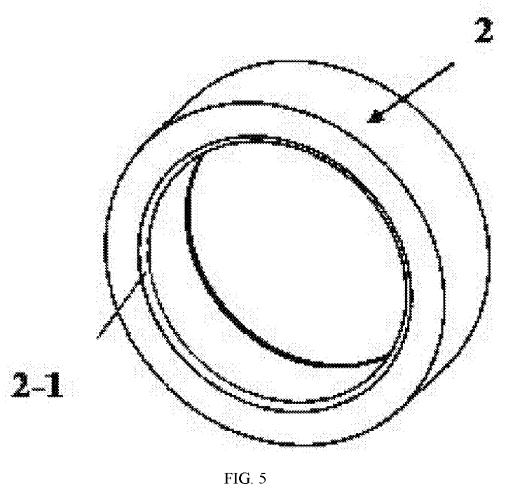

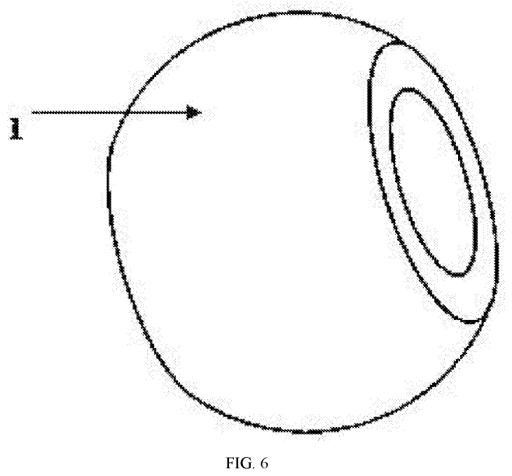

As shown in FIG. 1 to FIG. 6, an all-ceramic joint bearing used in a high-temperature, corrosion and oxidation-prone environment includes an inner ring 1 and an outer ring 2, where an inner side of the outer ring 2 is an inner arc surface, and an outer side of the outer ring 2 is a cylindrical outer surface; an outer side of the inner ring 1 is an outer arc surface, and an inner side thereof is a hollow cylinder 1-1; a bearing width of the inner ring 1 is 3-5 mm greater than that of the outer ring 2, the inner ring 1 can swing around in the outer ring 2, and a swing angle of the inner ring 1 is 0-21°; an inner wall of the outer ring 2 is closely attached to an outer wall of the inner ring 1; and the inner ring 1 and the outer ring 2 are made of zirconia, alumina or silicon carbide ceramic materials.

A diameter of the hollow cylinder 1-1 is 37.5% that of the outer side of the outer ring 2, and a wall thickness of the outer ring 2 is 1-4 mm. Upper and lower ends of the inner side of the outer ring 2 are provided with inclination angles 2-1.

Compared with metal joint bearings, the all-ceramic joint bearing has a low friction coefficient, high temperature resistance and high hardness, and the service performance and service life of the joint bearing are greatly improved. Thermal expansion coefficients of the zirconia ceramic material and metal are basically the same, and the installation process is basically the same as the installation mode of the metal material. The all-ceramic joint bearing is assembled in a way of thermal expansion of the outer ring and contraction of the inner ring.

Since the inner ring 1 of the joint bearing mainly bears pressure, in order to improve the compression resistance of the inner ring 1, a surface of the inner ring 1 is plated with a layer of diamond powder. In the application process of the joint bearing, friction easily occurs between the inner ring and the outer ring. In order to reduce the friction coefficient and improve the service life, the inner arc surface of the outer ring 2 is plated with a layer of graphene.

The foregoing descriptions are only preferred embodiments of the present invention. It should be noted that for a person of ordinary skill in the art, several improvements and modifications may further be made without departing from the principle of the present invention. These improvements and modifications should also be deemed as falling within the protection scope of the present invention.

What is claimed is:

1. An all-ceramic joint bearing used in a high-temperature, corrosion and oxidation-prone environment, comprising an inner ring and an outer ring, wherein an inner side of the outer ring is an inner arc surface, and an outer side of the outer ring is a cylindrical outer surface; an outer side of the inner ring is an outer arc surface, and an inner side thereof is a hollow cylinder; a bearing width of the inner ring is 3-5 mm greater than that of the outer ring, and a swing angle of the inner ring is 0-21°; an inner wall of the outer ring is closely attached to an outer wall of the inner ring; and the inner ring and the outer ring are made of zirconia, alumina or silicon carbide ceramic materials.

2. The all-ceramic joint bearing used in a high-temperature, corrosion and oxidation-prone environment according to claim 1, wherein a diameter of the hollow cylinder is 37.5% that of the outer side of the outer ring, and a wall thickness of the outer ring is 1-4 mm.

3. The all-ceramic joint bearing used in a high-temperature, corrosion and oxidation-prone environment according to claim 1, wherein upper and lower ends of the inner side of the outer ring are provided with inclination angles.

4. The all-ceramic joint bearing used in a high-temperature, corrosion and oxidation-prone environment according to claim 1, wherein a surface of the inner ring is plated with a layer of diamond powder and the inner arc surface of the outer ring is plated with a layer of graphene.
